(19) United States
(12) Patent Application Publication
(10) Pub. No.: US 2025/0223157 A1
(43) Pub. Date: Jul. 10, 2025

(54) ARC PLASMA REACTOR AND METHOD FOR REFORMING CARBON DIOXIDE AND METHANE USING SAME

(71) Applicant: Samsung Electronics Co., Ltd., Suwon-si (KR)

(72) Inventors: Jinwoo KIM, Suwon-si (KR); Hyukjae KWON, Suwon-si (KR); Dongwook KIM, Suwon-si (KR); Jongmin LEE, Suwon-si (KR); Junkyu KIM, Suwon-si (KR); Jaehee CHANG, Suwon-si (KR); Sungwoo KANG, Suwon-si (KR); Hyunah KIM, Suwon-si (KR)

(21) Appl. No.: 19/007,883

(22) Filed: Jan. 2, 2025

(30) Foreign Application Priority Data
Jan. 8, 2024 (KR) 10-2024-0003114

(51) Int. Cl. C01B 3/26; C01B 3/04; H05H 1/48

(52) U.S. Cl. CPC C01B 3/26; C01B 3/04; H05H 1/48; C01B 2203/0861; C01B 2203/1058; H05H 2245/10

(57) ABSTRACT

An arc plasma reactor includes a cylindrical surface, a gas inlet, an arc generation part, a catalyst filling part, and a gas outlet. The gas inlet is formed on the cylindrical surface and injects gas at an angle of 30 degrees (°) to 90° with respect to a long axis of the arc plasma reactor. The arc generation part includes a high voltage electrode disposed inside the arc plasma reactor and a ground electrode disposed on an inner wall of the arc plasma reactor. The catalyst filling part is disposed in an area outside the arc generating part, on an opposite side of the gas inlet, and an inside diameter of the arc plasma reactor in an area where the high voltage electrode is disposed is less than an inside diameter of the arc plasma reactor in an area where the catalyst filling part is disposed.

This application claims priority to Korean Patent Application No. 10-2024-0003114, filed on Jan. 8, 2024, and all the benefits accruing therefrom under 35 U.S.C. § 119, the content of which in its entirety is herein incorporated by reference.

### BACKGROUND

### 1. Field

The disclosure relates to an arc plasma reactor and a methane and carbon dioxide reforming method using the same.

### 2. Description of the Related Art

Methane, which makes up most of natural gas, is used in various fields as a raw material for energy production through combustion or as a raw material for producing synthetic gases through reforming. In addition, methane is a representative greenhouse gas along with carbon dioxide. A carbon dioxide-methane reforming system is substantially significant in terms of synthesis of useful gases while reducing greenhouse gas emissions. Although several studies are being conducted on carbon dioxide-methane reforming, it is desired to improve energy efficiency.

### SUMMARY

Provided is an arc plasma reactor for reforming carbon dioxide and methane gas, which provides relatively high energy efficiency.

Provided is a method for reforming carbon dioxide and methane gas having relatively high energy efficiency by the arc plasma reactor.

Additional features will be set forth in part in the description which follows and, in part, will be apparent from the description, or may be learned by practice of the presented embodiments of the disclosure.

In an embodiment of the disclosure, provided is an arc plasma reactor for reforming carbon dioxide and methane gas. The arc plasma reactor includes a cylindrical surface, a gas inlet, an arc generation part, a catalyst filling part, and a gas outlet. The gas inlet is formed on the cylindrical surface to inject gas at an angle of about 30° to about 90° with respect to a long axis of the arc plasma reactor, the arc generation part includes a high voltage electrode and a ground electrode. The high voltage electrode is disposed inside the arc plasma reactor, and the ground electrode is disposed on an inner wall of the arc plasma reactor, the catalyst filling part is disposed in an area outside the arc generation part, on an opposite side of the gas inlet, and assuming that an inside diameter of the arc plasma reactor in an area where the high voltage electrode is disposed is a, and an inside diameter of the arc plasma reactor in an area where the catalyst filling part is disposed is b, a is greater than b and an area where an inside diameter of the arc plasma reactor decreases from a to b is disposed within the arc generation part.

In an embodiment, the gas inlet may be formed on the cylindrical surface to inject the gas at an angle of about 0° to about 60° with respect to a surface in contact with the cylindrical surface.

In an embodiment, the gas inlet may include a plurality of gas inlets.

In an embodiment, in an embodiment, the gas inlet is connected to a carbon dioxide supply line, a methane supply line, and an inert gas supply line.

In an embodiment, the gas inlet is connected to a mixed gas line, and the mixed gas line is connected to the carbon dioxide supply line, the methane supply line, and the inert gas supply line.

In an embodiment, the arc generation part may include a diameter reduction area where the inside diameter of the arc plasma reactor decreases from a to b, the diameter reduction area is disposed in front of the high voltage electrode, and an inclination angle of the cylindrical surface in the diameter reduction area is about 20° to about 60°.

In an embodiment, the catalyst included in the catalyst filling part may include nickel and a metal oxide.

In an embodiment, the metal oxide may include an oxide of Mg, Ca, Ba, Na, Al, or a transition metal, or any combinations thereof.

In an embodiment, the transition metal may include Mn, Fe, Ti, Fe, Zr, Sr, La, Ce, Y or any combinations thereof.

In an embodiment, the catalyst may include NiₓMg_{y}O (0<x<1 and 0<y<1), LaNiₓM_{y}O_{3-d} (M=Al, Mn, or Fe) (0<x<1, 0<y<1, and 0≤d<0.5), or CaAₓB_{y}Ni_{z}O_{3-d} (A=Ti or Fe and B=Mn or Zr) (0<x<1, 0<y<1, and 0≤d<0.5) or a combination thereof.

In an embodiment, the nickel and the metal oxide may be mixed.

In an embodiment, when a voltage is applied to the high voltage electrode, a point where an arc is generated may rotate and change according to a flow of the gas injected into the gas inlet.

In another embodiment of the disclosure, a method for reforming carbon dioxide and methane gas includes injecting carbon dioxide, methane, and inert gas into the gas inlet of the arc plasma reactor, applying a relatively high voltage pulse to the high voltage electrode of the arc plasma reactor, and separating, through the gas outlet, hydrogen and carbon monoxide generated in the arc plasma reactor.

In an embodiment, the relatively high voltage pulse may have a pulse width of about 1 microsecond (μs) to about 100 us and a pulse period of about 1 kilohertz (kHz) to about 100 KHz.

In an embodiment, the relatively high voltage pulse may be in the form of alternating current voltage.

In an embodiment, the relatively high voltage pulse may have a maximum voltage of about 0.5 kilovolt (kV) to about 10 kV.

In an embodiment, a bulk velocity of the carbon dioxide, the methane and the inert gas in the arc plasma reactor may be about 1 meter per second (m/s) to about 100 m/s.

In an embodiment, the inert gas may be argon.

In another embodiment of the disclosure, a system for reforming carbon dioxide and methane gas includes the arc plasma reactor, a gas supply unit connected to the gas inlet of the arc plasma reactor, a power supply which supplies power to the high voltage electrode of the arc plasma reactor, a reformed gas storage unit connected to the gas outlet of the arc plasma reactor, a component analysis circuitry which analyzes components of gas in the gas storage unit, and a control circuitry which controls operation of the arc plasma reactor, the power supply, the gas supply unit, the reformed gas storage unit, and the component analysis circuitry.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a schematic cross-sectional view of an embodiment of an arc plasma reactor;

FIGS. 2 and 3 are schematic cross-sectional views along the long axis of a cylindrical body of a reactor, for explaining the shape of a gas inlet;

FIGS. 4 and 5 are schematic cross-sectional views along the short axis of a cylindrical body of a reactor, for explaining the shape of a gas inlet;

FIG. 6 is a configuration diagram of an embodiment of an arc plasma reactor system;

FIG. 7 is a flowchart for explaining a method for reforming carbon dioxide and methane by an arc plasma reactor; and

FIG. 8 is a graph showing, for Embodiment 1, changes in the conversion rates of carbon dioxide (CO2) and methane (CH4) and the selectivities of generated carbon monoxide (CO) and hydrogen (H2), over one hour.

### DETAILED DESCRIPTION

Reference will now be made in detail to embodiments, illustrative embodiments of which are illustrated in the accompanying drawings, where like reference numerals refer to like elements throughout. In this regard, the illustrated embodiments may have different forms and should not be construed as being limited to the descriptions set forth herein. Accordingly, the embodiments are merely described below, by referring to the drawing figures, to explain features. As used herein, the term “and/or” includes any and all combinations of one or more of the associated listed items. Expressions such as “at least one of,” when preceding a list of elements, modify the entire list of elements and do not modify the individual elements of the list.

Hereinafter, as the disclosure allows for various changes and numerous embodiments, particular embodiments will be illustrated in the drawings and described in detail in the detailed description. However, this is not intended to limit the disclosure to particular modes of practice, and it is to be appreciated that all changes, equivalents, and substitutes that do not depart from the spirit and technical scope are encompassed in the disclosure.

The terms used herein are merely used to describe particular embodiments, and are not intended to limit the disclosure. An expression used in the singular encompasses the expression of the plural, unless it has a clearly different meaning in the context. As used herein, it is to be understood that the terms such as “includes,” “have,” and “comprise” are intended to indicate the presence of the features, numbers, steps, actions, components, parts, ingredients, materials, or combinations thereof disclosed in the specification, but do not preclude the possibility that one or more other features, numbers, steps, actions, components, parts, ingredients, materials, or combinations thereof may exist or may be added. The symbol “/” used herein may be interpreted as “and” or “or” according to the context.

In the drawings, the diameters, lengths, and thicknesses of layers and regions are exaggerated or reduced for clarity. Throughout the specification, like reference numerals refer to like elements. Throughout the specification, it is to be understood that when a component, such as a layer, a film, a region, or a plate, is referred to as being “on” another component, the component may be directly on the other component or intervening components may be thereon. Throughout the specification, the terms “first,” “second,” etc. may be used to describe various elements, these elements, components, regions, layers and/or sections should not be limited by these terms. These terms are only used to distinguish one element from another element. In this specification and drawings, components having substantially the same functional configuration are given the same reference numerals, and redundant description is omitted.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

### <Arc Plasma Reactor>

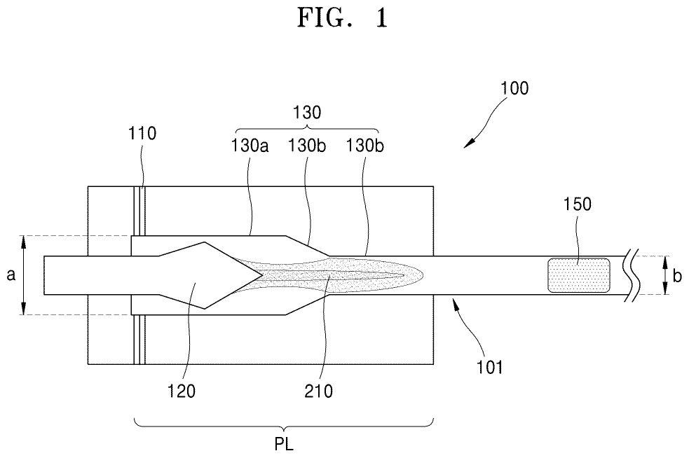

FIG. 1 is a schematic cross-sectional view of an embodiment of an arc plasma reactor 100. Referring to FIG. 1, the arc plasma reactor 100 includes a body 101, a gas inlet 110, a high voltage electrode 120 and a ground electrode 130, and a catalyst filling part 150.

Reaction gas including or consisting of injected carbon dioxide and methane is reformed into carbon monoxide and hydrogen while passing through a plasma discharge area and the catalyst filling part 150.

The body 101 has a cylindrical interior and has the high voltage electrode 120 inside, and the ground electrode 130 is formed at the body 101. The high voltage electrode 120 and the ground electrode 130 define the plasma discharge area.

The high voltage electrode 120 is an electrode to which a relatively high voltage is applied to generate an arc, and is disposed at one end of the body 101. The high voltage electrode 120 may have a cone shape.

When the ground electrode 130 has a predetermined distance from the high voltage electrode 120, arc plasma may be generated by a voltage difference between the high voltage electrode 120 and the ground electrode 130.

The inside diameter of the body 101 forming the ground electrode 130 gradually decreases in the direction in which the arc plasma travels in front of the high voltage electrode 120. Accordingly, the body 101 has a funnel shape in which the diameter of the area far from the high voltage electrode 120 is smaller than the diameter of the area close to the high voltage electrode 120. That is, when the diameter (also referred to as a first inside diameter) of the cylindrical interior surrounding the high voltage electrode 120 is a, and the diameter (also referred to as a second inside diameter) of a cylindrical space at a predetermined distance away from the high voltage electrode 120 in the direction in which the plasma travels is b, b is smaller than a.

In an embodiment, the inclination angle of the cylindrical surface in the diameter reduction area may be 10° to 70°, 20° to 60°, or 30° to 50°, for example, with respect to the long axis of the arc plasma reactor.

Arc plasma may be formed in the arc generation part PL within a predetermined distance from the high voltage electrode 120 inside the arc plasma reactor. As the ground electrode 130, which is the inner surface of the body 101, is narrowed in diameter within the arc generation part PL, the arc plasma generated between the high voltage electrode 120 and the ground electrode 130 may have a linear shape. The linear arc plasma may be advantageous in forming a localized ultra-high temperature region.

The high voltage electrode 120 and the ground electrode 130 may include or consist of heat-resistant metal, including stainless steel, carbon steel, or Inconel, for example.

Carbon dioxide, methane, and inert gas are injected into the arc plasma reactor through the gas inlet 110. Carbon dioxide and methane are gases that participate in a reforming reaction, and inert gas is a gas for facilitating the generation of plasma. The inert gas may be argon gas, for example.

The gas inlet 110 is formed on the cylindrical surface of the body 101. The gas inlet 110 may be formed to have an angle of 30° to 90°, e.g., 45° to 90°, e.g., 60° to 90°, e.g., 75° to 90°, with respect to the long axis of the cylindrical body 101.

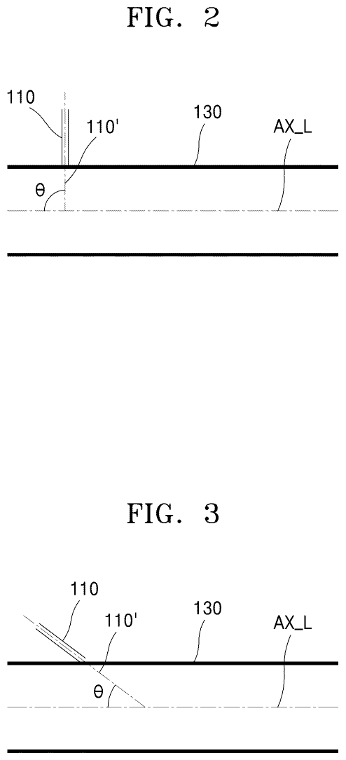

FIGS. 2 and 3 are schematic cross-sectional views along the long axis of a cylindrical body 101 of the arc plasma reactor for explaining the shape of a gas inlet 110. Referring to FIG. 2, the angle θ defined by an extension line 110′ of the gas inlet 110 with respect to the long axis AX_L of the cylindrical body 101 is 90°. Referring to FIG. 3, the angle θ defined by the extension line 110′ of the gas inlet 110 with respect to the long axis AX_L of the cylindrical body 101 is 45°.

In an embodiment, the gas inlet 110 may form an angle of 0° to 60° with respect to a surface in contact with the cylindrical body 101 at a point where the gas inlet 110 is connected to the cylindrical body 101.

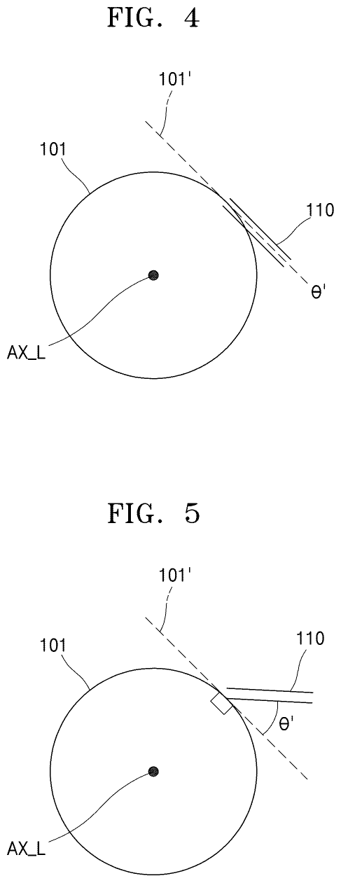

FIGS. 4 and 5 are schematic cross-sectional views along the short axis of a cylindrical body 101 of a reactor for explaining the shape of the gas inlet 110. Referring to FIG. 4, at a point where the gas inlet 110 is connected to the cylindrical body 101, the angle (θ′) defined by the gas inlet 110 with respect to a surface 101′ in contact with the cylindrical body 101 is 0°. Referring to FIG. 5, at a point where the gas inlet 110 is connected to the cylindrical body 101, the angle (θ′) defined by the gas inlet 110 with respect to the surface 101′ in contact with the cylindrical body 101 is 45°.

Although one gas inlet 110 is described in FIGS. 2 to 5, the arc plasma reactor 100 may have a plurality of gas inlets 110. In an embodiment, the arc plasma reactor 100 may have two, three, four, five, or six gas inlets 110, for example, but the number thereof is not limited thereto. When the arc plasma reactor 100 has a plurality of gas inlets 110, a more uniform plasma may be generated by generating a rotationally symmetrical flow about the long axis.

When the arc plasma reactor 100 has the body 101 and the gas inlet 110, as stated above, the reaction gas may flow in while rotating around the high voltage electrode 120 in a space between the cone-shaped high voltage electrode 120 and the ground electrode 130. The reaction gas is introduced in a rotating manner, and thus a point where an arc is generated may rotate together. When the arc is generated at a fixed point, the point where the arc is generated may be locally worn down or abraded in the high voltage electrode 120 or the ground electrode 130. In an embodiment, an end of the cone of the high voltage electrode 120 is prone to abrasion, and in the case of the ground electrode 130, the surface thereof becomes rough due to local abrasion, which may further accelerate electrode abrasion, for example. In the arc plasma reactor 100 in the illustrated embodiment, the arc generation point is not be fixed but rotates, thereby preventing local abrasion of the high voltage electrode 120 and the ground electrode 130.

In addition, in the arc plasma reactor 100 in the illustrated embodiment, even when the reaction gas is injected at a relatively high flow rate, the form in which the reaction gas is introduced while maintaining a quick rotation, so that the contact frequency of the reaction gas with linear discharging may be increased, thereby stably maintaining high-energy plasma.

The gas inlet 110 is connected to a carbon dioxide supply line, a methane supply line, and an inert gas supply line. In an embodiment, the carbon dioxide supply line, the methane supply line, and the inert gas supply line may be connected to form a mixed gas line, and the gas inlet 110 may be connected to the mixed gas line.

The reaction gases, that is, carbon dioxide and methane gas injected through the gas inlet 110, pass through the space between the high voltage electrode 120 and the ground electrode 130 of the arc generation part and are converted into plasma. In the plasma discharge area, reforming of the reaction gas is achieved through direct bond decomposition as the reaction gas is converted into a plasma and thermodynamic bond decomposition by receiving heat from the gas converted into a plasma.

The catalyst filling part 150 is disposed in an area outside the arc generation part on the opposite side of the gas inlet.

Carbon monoxide and hydrogen are generated by reforming the reaction gas in the plasma discharge area, but unreformed reaction gas may remain in a state of high-energy chemical species in the plasma discharge area. A strong vortex flow including or consisting of the reformed gas generated by plasma and the high-energy state chemical species passes through the catalyst filling part 150. Here, the high-energy state chemical species may supply activation energy to the catalyst by a direct contact with the catalyst, and additional reforming of the unreformed reaction gas may be performed in the catalyst filling part 150.

In addition, carbon powder derived from carbon dioxide and methane gas generated in the arc generation part may be disposed between catalyst particles or on catalyst particles of the catalyst filling part 150 and participate as an additional catalyst in the reforming of the reaction gas. The carbon powder in the catalyst filling part 150 does not form bonds with the catalyst particles and does not reduce catalyst activity. This may reduce the final remaining amount of carbon powder in the arc plasma reactor or after the catalyst filling part 150. When the carbon powder derived from carbon dioxide and methane gas clogs a reactor pipe, an increase in the pressure within the arc plasma reactor, suppression of reformed gas emissions, and a system overload, may be caused, and thus it is advantageous to reduce the remaining amount of carbon powder.

In an embodiment, the catalyst of catalyst filling part 150 may include a combination of an active metal and a metal oxide. In another embodiment, the catalyst may be formed by coating a catalytically active metal on the surface of a metal oxide. By using catalytically active metals mixed or coated with metal oxides that are stable in various chemical reaction environments, the form and performance of the catalyst may be maintained in the plasma reactor.

In an embodiment, the active metal may include nickel. In an embodiment, the metal oxide may include an oxide of Mg, Ca, Ba, Na, Al, or a transition metal, or any combinations thereof. The transition metal may include Mn, Fe, Ti, Fe, Zr, Sr, La, Ce, Y, or any combinations thereof, for example. In an embodiment, the catalyst may include NiₓMg_{y}O (0<x<1 and 0<y<1), LaNiₓM_{y}O_{3-d} (M=Al, Mn or Fe) (0<x<1, 0<y<1, and 0<d<0.5), or CaAₓB_{y}Ni_{z}O_{3-d} (A=Ti or Fe, B=Mn or Zr) (0<x<1, 0<y<1, and 0<d<0.5), or a combination thereof, for example.

In a general thermal catalytic reforming reactor, heating a catalyst is time-consuming, making it difficult to immediately start or end the reforming reaction. However, in the arc plasma reactor in the illustrated embodiment, the catalyst in a catalyst filling part may be activated immediately upon contact with high-energy gas generated by an arc plasma, thereby enabling immediate initiation and termination of the reforming reaction.

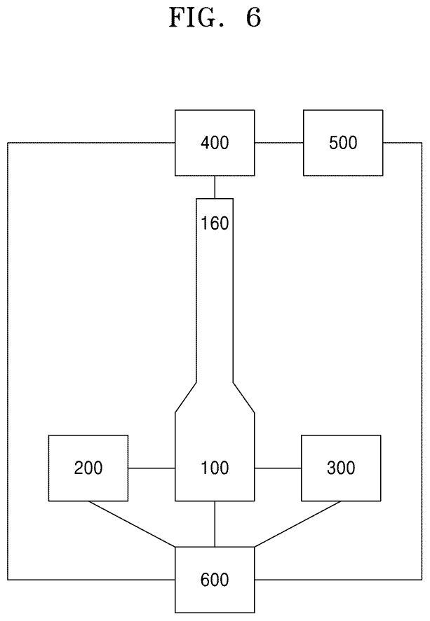

FIG. 6 is a configuration diagram of an embodiment of an arc plasma reactor system. Referring to FIG. 6, the arc plasma reactor system in an embodiment includes: the arc plasma reactor 100; a gas supply unit 200 connected to the gas inlet of the arc plasma reactor 100; a power supply 300 that supplies power to the high voltage electrode of the arc plasma reactor 100; a reformed gas storage unit 400 connected to the gas outlet 160 of the arc plasma reactor 100; a component analysis circuitry 500 that analyzes components of the gas in the reformed gas storage unit; and a control circuitry 600 that controls the operations of the arc plasma reactor 100, the gas supply unit 200, the power supply 300, the reformed gas storage unit 400, and the component analysis circuitry 500.

The gas supply unit 200 is a unit that supplies carbon dioxide, methane, and inert gas that react within the arc plasma reactor. The gas supply unit 200 may supply each gas by adjusting the flow rate of each gas by a mass flow meter, for example. In addition, carbon dioxide, methane, and inert gas may be mixed and supplied in an appropriate ratio.

The power supply 300 is a unit capable of supplying alternating current power or direct current power, and may apply a pulse voltage to a relatively high voltage electrode. In an embodiment, hydrogen and carbon monoxide generated in the arc plasma reactor 100 may be separated through the gas outlet 160 of the arc plasma reactor 100. The reformed gas storage unit 400 is a unit that stores reformed gases, that is, carbon monoxide and hydrogen, generated by a reaction of carbon dioxide and methane in the arc plasma reactor 100. The component analysis circuitry 500 is a unit capable of analyzing components of the generated gas and may include an analysis device such as a gas chromatograph. The control circuitry 600 is a unit capable of controlling the operation of each unit of the carbon dioxide and methane reforming system and may include a computer.

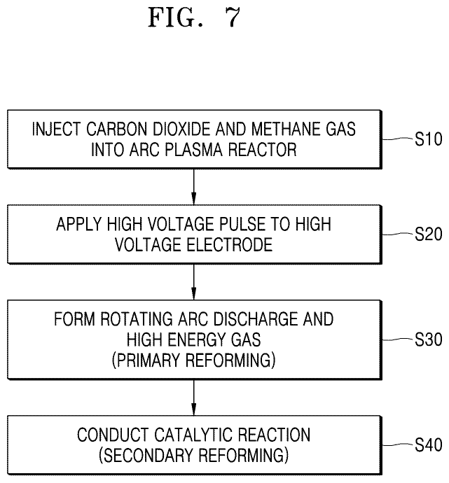

FIG. 7 is a flowchart for explaining a method of reforming carbon dioxide and methane by an arc plasma reactor.

Referring to FIG. 7, carbon dioxide and methane gas, which are reaction gases, are injected into the arc plasma reactor through a gas inlet (S10). Here, inert gas may be added to facilitate the generation of arc plasma. The inert gas may include argon, for example. The reaction gas may be a mixed gas of carbon dioxide, methane, and inert gas. The reaction gas injected through the gas inlet is injected into the arc plasma reactor in a rotating manner while surrounding the high-voltage electrode, thereby generating a rotating arc along the flow of the reaction gas. The reaction gas does not include or consist of oxygen that may corrode an electrode at relatively high temperatures. The injection flow rate of the reaction gas may be adjusted so that the linear velocity or bulk velocity of the reaction gas within the arc plasma reactor is 1 meter per second (m/s) to 100 m/s. When the speed of the reaction gas within the arc plasma reactor is within the range stated above, the rotational flow of the reaction gas and the resulting rotating arc may be maintained, and the reaction gas and/or high-energy gas formed from the reaction gas may pass through the catalyst filling part to form reformed gas.

A relatively high voltage pulse is applied to the high voltage electrode of the arc plasma reactor (S20). In an embodiment, the relatively high voltage pulse may have a pulse width of 1 microsecond (μs) to 100 us and a pulse period of 1 kilohertz (kHz) to 100 kHz. The relatively high voltage pulse may have a maximum voltage of, e.g., 0.5 kilovolt (kV) to 10 kV.

By applying a pulse voltage having a microsecond width to the high voltage electrode, the maintenance time and stroke time of linear arc discharge may be controlled by the pulse width. The stroke time is a time for plasma once generated to be maintained. When the pulse width is too short, arc discharge does not provide enough energy for gas reforming, and when the pulse width is too long, an arc discharge is generated discontinuously and repeatedly within one pulse, which may increase the volume of untreated gas. By applying a pulse voltage in the range stated above, the linear arc discharge may be maintained. Maintaining the linear arc discharge is advantageous in forming a local ultra-high temperature region.

In an embodiment, when a pulse voltage is applied as alternating current voltage, the overall energy of the reaction gas may be controlled through the control of the frequency of occurrence of linear discharges by alternating-current frequency. By controlling the overall energy of the gas, the gas temperature and reforming efficiency may be controlled.

Rotating arc discharge is caused by applying a relatively high voltage pulse, and relatively high energy gas is formed (S30). The point where an arc discharge is generated rotates and moves, but the overall shape of the arc discharge is linear. The high-energy gas formed from the reaction gas reacts with the plasma of this arc discharge to form a primarily reformed gas. The primarily reformed gas may include or consist of high-energy chemical species that have not yet been reformed, in addition to carbon monoxide and hydrogen formed by reforming.

The gas including or consisting of the high-energy chemical species may form a secondarily reformed gas by conducting a catalytic reaction while passing through the catalyst filling part (S40). Carbon monoxide and hydrogen may be additionally generated through secondary reforming in the catalyst filling part, and the conversion rates of carbon dioxide and methane, selectivities of carbon monoxide and hydrogen, and energy efficiencies, may be improved.

### EMBODIMENTS

The disclosure is explained in more detail through the following examples and comparative examples. However, the following examples are provided for illustrating the disclosure and are not intended to limit the scope of the disclosure.

### Embodiment 1

A cylindrical arc plasma reactor was used, which has an inner diameter of 17 millimeters (mm) on a high voltage electrode side, an inner diameter of 8 mm on a catalyst filling part side, and a length of 300 mm. The high voltage electrode in the arc plasma reactor was in the shape of a cone, with the largest diameter of the cone being 15 mm and a length of 30 mm. The inner wall of the arc plasma reactor, which constitutes a ground electrode, includes or consists of an Inconel material. The catalyst filling part was filled with 0.5 g of Ni_{0.4}Mg_{0.6}O catalyst in the form of granules having a size of 800 μm to 1 mm. The reformed gas discharged from the arc plasma reactor was allowed to pass through gas chromatography.

The arc plasma reactor was operated continuously for one hour by applying a micropulse waveform voltage of maximum voltage of 3 kV, pulse width of 6μ, and frequency of 60 KHz.

Carbon dioxide (CO₂), methane (CH₄), and argon (Ar) gas were injected through a gas inlet of the arc plasma reactor at flow rates of 1.8 liter per minute (“Lpm”) (L/min), 1.2 Lpm, and 7 Lpm, respectively. Four gas inlets were formed near a start portion of the high voltage electrode of the arc plasma reactor. Each gas inlet was brought into contact with the cylindrical surface of the arc plasma reactor at an angle of 90° with respect to the long axis of a cylinder of the arc plasma reactor and an angle of 0° with respect to the cross section perpendicular to the long axis of the cylinder.

### Embodiments 2 to 6

Carbon monoxide (CO) and hydrogen (H₂) were generated from carbon dioxide (CO₂) and methane (CH₄) by an arc plasma reactor in the same manner as in Embodiment 1, except that the catalysts listed in Table 1 were used, instead of the Ni_{0.4}Mg_{0.6}O catalyst in a catalyst filling part.

### Comparative Example 1

Carbon monoxide (CO) and hydrogen (H₂) were generated from carbon dioxide (CO₂) and methane (CH₄) by an arc plasma reactor in the same manner as in Embodiment 1, except that a catalyst was not used in a catalyst filling part.

TABLE 1

| | Catalyst |
|---|---|
| Embodiment 1 | Ni_{0.4}Mg_{0.6}O |
| Embodiment 2 | LaNi_{0.5}Al_{0.5}O₃ |
| Embodiment 3 | LaNi_{0.5}Mn_{0.5}O₃ |
| Embodiment 4 | LaNi_{0.5}Fe_{0.5}O₃ |
| Embodiment 5 | CaTi_{0.48}Mn_{0.48}Ni_{0.04}O₃ |
| Embodiment 6 | CaFe_{0.48}Zr_{0.48}Ni_{0.04}O₃ |
| Comparative | No catalyst used |
| Example 1 | |

### Evaluation of Embodiments and Comparative Example

In Embodiments 1 to 6 and Comparative Example 1, the plasma reactor was continuously operated for one hour and gas chromatography was performed at 10-minute intervals to measure the concentration of gas components discharged from the arc plasma reactor.

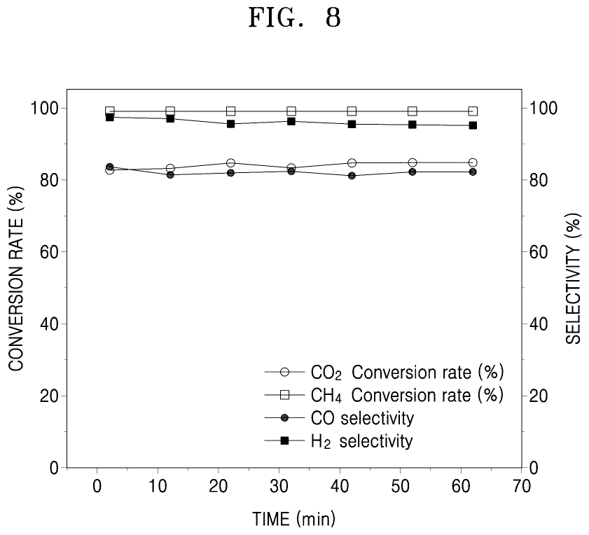

For Embodiment 1, changes in the conversion rates of carbon dioxide (CO₂) and methane (CH₄) and the selectivities of generated carbon monoxide (CO) and hydrogen (H₂), over one hour, are shown in FIG. 8. Referring to FIG. 8, the conversion rates of carbon dioxide (CO₂) and methane (CH₄) and the selectivities of generated carbon monoxide (CO) and hydrogen (H₂) for one hour, vary within the ranges of 2.5%, 0.26%, 2.5%, and 3.0%, respectively, compared to average values. From this, it may be confirmed that the reforming reaction is occurring stably during the continuous operation time of one hour.

The average conversion rates of carbon dioxide (CO₂) and methane (CH₄), the selectivities of generated carbon monoxide (CO) and hydrogen (H₂) in Embodiments 1 to 6 and Comparative Example 1, as obtained from the measurement by gas chromatography, the average selectivities of generated carbon monoxide (CO) and hydrogen (H₂), and the average energy efficiency of reforming, are shown in Table 2.

The conversion rates of carbon dioxide (CO₂) and methane (CH₄), the selectivities of generated carbon monoxide (CO) and hydrogen (H₂), and the energy efficiency of reforming, were calculated by Equations (1) to (5) below.

The values of the conversion rates, selectivities, and energy efficiencies, shown in Table 2, are average values of the conversion rates, selectivities, and energy efficiencies, obtained from gas chromatography data measured every 10 minutes during the operation time of the plasma reactor.

$${CO}_{2} conversion rate = ( 1 - \frac{{CO}_{2 ( o u t )}}{{CO}_{2 ( i n )}} ) \times 100 \qquad ( 1 )$$

$${CH}_{4} conversion rate = ( 1 - \frac{{CH}_{4 ( o u t )}}{{CH}_{4 ( i n )}} ) \times 100 \qquad ( 2 )$$

$$CO selectivity ( \% ) = ( \frac{{CO}_{( o u t )}}{( {CO}_{2 ( i n )} - {CO}_{2 ( out )} ) + ( {CH}_{4 ( i n )} - {CH}_{4 ( out )} )} ) \times 100 \qquad ( 3 )$$

$${H}_{2} selectivity ( \% ) = ( \frac{{H 2}_{( o u t )}}{2 * ( {CH}_{4 ( i n )} - {CH}_{4 ( out )} )} ) \qquad ( 4 )$$

$$Energy efficiency ( \% ) = \frac{Minimum conversion energy per molecule}{Energy input per converted molecule} \times 100 \qquad ( 5 )$$

In Equations (1) to (5) above, CO₂₍ᵢₙ₎ denotes the amount of CO₂ injected into the arc plasma reactor, CO₂₍ₒᵤₜ₎ denotes the amount of CO₂ discharged from the arc plasma reactor after the reaction, CH₄₍ᵢₙ₎ denotes the amount of CH₄ injected into the arc plasma reactor, CH₄₍ₒᵤₜ₎ denotes the amount of CH₄ discharged from the arc plasma reactor after the reaction, CO₍ₒᵤₜ₎ denotes the amount of CO produced and discharged after the reaction, and H₂₍ₒᵤₜ₎ denotes the amount of H₂ produced and discharged after the reaction.

The minimum conversion energy per molecule is calculated by a difference between the molecular energy levels before and after conversion, and the energy input per converted molecule is calculated by the measured energy consumption and the amount of reformed gas.

TABLE 2

| | CO₂ | CH₄ | | | |
|---|---|---|---|---|---|
| | con- | con- | | | Energy |
| | version | version | CO | H₂ | effici- |
| | rate | rate | Selectivity | Selectivity | ency |
| | (%) | (%) | (%) | (%) | (%) |
| Embodiment 1 | 83.89 | 99.06 | 95.87 | 82.00 | 60.41 |
| Embodiment 2 | 84.38 | 94.84 | 87.45 | 99.59 | 67.3 |
| Embodiment 3 | 79.77 | 88.77 | 98.81 | 85.22 | 60.9 |
| Embodiment 4 | 77.20 | 83.41 | 90.06 | 91.81 | 57.0 |
| Embodiment 5 | 74.93 | 80.52 | 89.61 | 91.36 | 55.4 |
| Embodiment 6 | 69.84 | 81.00 | 86.90 | 84.77 | 57.1 |
| Comparative | 66.65 | 82.99 | 92.14 | 80.46 | 53.0 |
| Example 1 | | | | | |

The carbon dioxide (CO₂) conversion rates, hydrogen (H₂) selectivities, and reforming energy efficiencies in Embodiments 1 to 6 appear to be higher than in Comparative Example 1. In addition, the methane (CH₄) conversion rates in Embodiments 1 to 4 appear to be higher than in Comparative Example 1, and the carbon monoxide (CO) selectivity of Embodiments 1 and 3 appears to be higher than that of Comparative Example 1.

An arc plasma reactor according to one feature may provide improved energy efficiencies for reforming carbon dioxide and methane gas.

Although embodiments have been described in detail with reference to the attached drawings, the disclosure is not limited to these embodiments. It is obvious that one skilled in the art to which the disclosure belongs may derive various embodiments of changes or modifications within the spirit and scope of the appended claims, and these naturally also fall within the technical scope of the disclosure.

It should be understood that embodiments described herein should be considered in a descriptive sense only and not for purposes of limitation. Descriptions of features or advantages within each embodiment should typically be considered as available for other similar features or advantages in other embodiments. While illustrative embodiments have been described with reference to the drawing figures, it will be understood by those of ordinary skill in the art that various changes in form and details may be made therein without departing from the spirit and scope as defined by the following claims.

What is claimed is:

1. An arc plasma reactor for reforming carbon dioxide and methane gas, the arc plasma reactor comprising:
a cylindrical surface;
a gas inlet which is formed on the cylindrical surface and injects a gas at an angle of about 30° to about 90° with respect to a long axis of the arc plasma reactor;
an arc generation part including:
a high voltage electrode disposed inside the arc plasma reactor; and
a ground electrode which is disposed on an inner wall of the arc plasma reactor;
a catalyst filling part which is disposed in an area outside the arc generation part, on an opposite side of the gas inlet; and
a gas outlet,
wherein a first inside diameter of the arc plasma reactor in an area where the high voltage electrode is disposed is greater than a second inside diameter of the arc plasma reactor in an area where the catalyst filling part, and
an area where an inside diameter of the arc plasma reactor decreases from the first inside diameter to the second inside diameter is disposed within the arc generation part.

2. The arc plasma reactor of claim 1, wherein the gas inlet is formed on the cylindrical surface to inject the gas at an angle of about 0° to about 60° with respect to a surface in contact with the cylindrical surface.

3. The arc plasma reactor of claim 1, wherein the gas inlet includes a plurality of gas inlets.

4. The arc plasma reactor of claim 1, wherein the gas inlet is connected to a carbon dioxide supply line, a methane supply line, and an inert gas supply line.

5. The arc plasma reactor of claim 4, wherein the gas inlet is connected to a mixed gas line, and the mixed gas line is connected to the carbon dioxide supply line, the methane supply line, and the inert gas supply line.

6. The arc plasma reactor of claim 1, wherein the arc generation part comprises a diameter reduction area where the inside diameter of the arc plasma reactor decreases from a to b, the diameter reduction area is disposed in front of the high voltage electrode, and an inclination angle of the cylindrical surface in the diameter reduction area is about 20° to about 60°.

7. The arc plasma reactor of claim 1, wherein a catalyst included in the catalyst filling part includes nickel and a metal oxide.

8. The arc plasma reactor of claim 7, wherein the metal oxide includes an oxide of Mg, Ca, Ba, Na, Al, or a transition metal, or any combinations thereof.

9. The arc plasma reactor of claim 8, wherein the transition metal includes Mn, Fe, Ti, Fe, Zr, Sr, La, Ce, Y or any combinations thereof.

10. The arc plasma reactor of claim 7, wherein the catalyst includes NixMgyO (0<x<1 and 0<y<1), LaNiₓM_{y}O_{3-d} (M=Al, Mn, or Fe) (0<x<1, 0<y<1, and 0≤d<0.5), CaAₓB_{y}Ni_{z}O_{3-d} (A=Ti or Fe and B=Mn or Zr) (0<x<1, 0<y<1, and 0≤d<0.5) or a combination thereof.

11. The arc plasma reactor of claim 7, wherein the nickel and the metal oxide are mixed.

12. The arc plasma reactor of claim 1, wherein the high voltage electrode has a cone shape.

13. The arc plasma reactor of claim 1, wherein in a case that a voltage is applied to the high voltage electrode, a point where an arc is generated rotates and changes according to a flow of the gas injected into the gas inlet.

14. A method for reforming carbon dioxide and methane, the method comprising:
injecting carbon dioxide, methane, and inert gas into a gas inlet included in an arc plasma reactor;
applying a relatively high voltage pulse to a high voltage electrode of an arc generation part included in the arc plasma reactor; and
separating, through a gas outlet included in the arc plasma reactor, hydrogen and carbon monoxide generated in the arc plasma reactor,
wherein the gas inlet is formed on a cylindrical surface of the arc plasma reactor and injects a gas at an angle of 30° to 90° with respect to a long axis of the arc plasma reactor,
the high voltage electrode is disposed inside the arc plasma reactor,
the arc generation part further includes:
a ground electrode which is disposed on an inner wall of the arc plasma reactor,
a catalyst filling part disposed in an area outside the arc generation part, on an opposite side of the gas inlet,
a first inside diameter of the arc plasma reactor in an area where the high voltage electrode is disposed is greater than a second inside diameter of the arc plasma reactor in an area where the catalyst filling part, and
an area where an inside diameter of the arc plasma reactor decreases from the first inside diameter to the second inside diameter is disposed within the arc generation part.

15. The method of claim 14, wherein the relatively high voltage pulse has a pulse width of about 1 microsecond to about 100 microseconds and a pulse period of about 1 kilohertz to about 100 kilohertz.

16. The method of claim 14, wherein the relatively high voltage pulse is in a form of an alternating current voltage.

17. The method of claim 14, wherein the relatively high voltage pulse has a maximum voltage of about 0.5 kilovolt to about 10 kilovolts.

18. The method of claim 14, wherein a bulk velocity of the carbon dioxide, the methane and the inert gas in the arc plasma reactor is about 1 meter per second to about 100 meters per second.

19. The method of claim 14, wherein the inert gas is argon.

20. A system for reforming carbon dioxide and methane gas, the system comprising:
the arc plasma reactor of claim 1;
a gas supply unit connected to the gas inlet of the arc plasma reactor;
a power supply which supplies power to the high voltage electrode of the arc plasma reactor;
a reformed gas storage unit connected to the gas outlet of the arc plasma reactor;
a component analysis circuitry which analyzes components of the gas in the reformed gas storage unit; and
a control circuitry which controls operation of the arc plasma reactor, the power supply, the gas supply unit, the reformed gas storage unit, and the component analysis circuitry.
